(19) United States
(12) Patent Application Publication
(10) Pub. No.: US 2008/0243643 A1
(43) Pub. Date: Oct. 2, 2008

(54) METHOD OF MERCHANDISING ARTICLE PERSONALIZATION SERVICES

(76) Inventor: NATALIE KNIGHT, Houston, TX (US)

Correspondence Address: TIMOTHY F. MILLS, 1177 WEST LOOP SOUTH, SUITE 400, HOUSTON, TX, 77027-9012, US

(21) Appl. No.: 12/060,250

(22) Filed: Mar. 31, 2008

Related U.S. Application Data
(60) Provisional application No. 60/921,008, filed on Mar. 31, 2007.

(51) Int. Cl. G06F 7/00; G06Q 30/00; G06F 19/00; G06Q 90/00

(52) U.S. Cl. 705/27; 705/1; 700/131

(57) ABSTRACT

A method, and an article produced thereby, of merchandising article personalization services at a retail location to a customer is provided. The article and embellishments are chosen by the customer, and the personalization implemented by the customer in a hands-on environment, or with the aid of store workers. The retail store also provides for groups of individuals to participate in article personalization events or parties. The customer is enabled to complete personalization of an article according to their time and ability using the professional services provided by the retail store personnel and equipment. Embellishment selections requiring trained personnel and specialized equipment are given to a store worker for processing. A method of performing the personalizing services over a computer network is also provided. The completed article is given to the customer, retained at the retail establishment until the customer returns, or forwarded to the customer at their request.

### CROSS-REFERENCE TO RELATED APPLICATION

Claims priority from U.S. Provisional Patent Application No. 60/921,008 filed Mar. 31, 2007.

### STATEMENT REGARDING FEDERALLY FUNDED SPONSORED RESEARCH OR DEVELOPMENT

Not applicable.

### BACKGROUND OF THE INVENTION

1. Field of the Invention

Decoration or embellishment of clothing articles generally encompasses addition of fabric, thread, paint or dye, or other embellishments such as beads or jewelry-like elements to the article after it has been produced or purchased by a customer. Professional clothing designers have training and experience, facilities, machines and trained workers to complete their expensive creations for individuals, celebrities, theater, film and couture. Until the method of the present invention, there was no inexpensive existing retail method for consumers, or a group of consumers, who could not afford the individual services of a clothing design professional, to customize an article of clothing with access to experienced clothing professionals, facilities and machines. Typically, the customer has to go to one store to buy the article of clothing, and one or more different stores or sources to obtain the clothing embellishment(s). The consumer, or a group of consumers, then gathers the materials in what ever work space is available to complete embellishment of the clothing. Disadvantages of such a process are that the consumer has to spend a lot of time obtaining the clothing and embellishments, usually from more than one source, then must find an available workspace for a period of time, then find available machines, but is limited to the functionality of whatever machines are available, and must complete the embellishment(s) without the aid of professional or trained assistance during the process.

The present invention relates generally to a method of merchandising, or offering for sale to the public, personalization services to produce customized apparel, including but not limited to shirts, blouses, skirts, dresses, pants, jeans, under garments, other apparel, or other articles such as jewelry, wine bottle covers, pillow cases, totes, aprons and Christmas stockings, whose appearance is modified by customer choices in a retail sales environment, or by retail online selection and ordering.

One aspect of the present invention is to provide a business method that enables a consumer to have an article personalized to suit the desires of the customer at a retail establishment or online without having to buy the article or embellishments prior to the process. The business method may be implemented through providing the service at a retail establishment or through a proprietary web portal programmed to accept orders for personalization of the article.

In a retail sales embodiment of the invention, the customer goes to the retail store, physically chooses an article to personalize and then chooses one or more available embellishments, including but not limited to embroidery, fabric and paint, for addition to the article. The type of embellishment determines the method of application and the expertise required. The designs may be available from written or printed reference sources, provided by the customer, or from a compilation or database available from the seller in written form or in digital form accessible on a computer.

In a further embodiment, a customer may connect to a web site comprising a plurality of articles, designs and embellishments, input choices of article(s) to customize, input selections of designs to customize and personalize an article, then place the order with the seller. The seller completes the customized article as designed by the customer and delivers the completed personalized article to the customer.

In a further embodiment the retail sales environment provides a work space for an individual, a family, or even a group of individuals to participate in the selection and customization of articles. Groups of individuals including but not limited to birthday celebrants, sports teams, and business associates may congregate in the retail establishment for the purpose of customizing such articles. A further advantage is the gathering may be promoted as a party for entertainment and social interaction.

In a further embodiment the method of the present invention provides a network accessible online proprietary web portal application with a centralized database and command functions to implement article selection and personalization. Thus the customer can access the proprietary application and data at a computer terminal in the retail store or remotely via a network accessible computer. This centralized database may be updated at any time to incorporate data of the latest fashion trends. In addition, the centralized data storage capability may be utilized to store customer personalization selection information for re-use, or for placement in a tag or label for the personalized article.

Never before has there been a comprehensive yet inexpensive retail or online source for article personalization. The method of the present invention provides customers with a retail space and tools to self implement and manage personalization of an article to their needs.

To ensure successful implementation of personalization selections, whether by utilizing the web portal or in-store instruction, the method provides a centralized location, either a retail store or a web portal, for customers to access apparel and embellishment data, machines and tools, customization recommendations, a step-by-step process to completion, and the necessary tools for the consumer.

2. Description of Related Art

Various attempts have been made to develop ways to customize apparel for the consumer. A common method still in extensive use is for the consumer to go to a local craft store, buy the selected embellishment, and apply it at home to an article of apparel. More fortunate consumers have access to expensive machines that can apply elaborate or intricate designs by embroidery, heat, etc., or take the article to a professional tailor or clothier with instructions on application. These processes can take days to weeks to personalize one article of apparel.

A method and apparatus for producing custom manufactured apparel items is provided in Burton et al., U.S. Pat. No. 4,598,376, granted Jul. 1, 1986, describing an automated made-to-measure garment manufacturing method and apparatus. The measurements of a customer were taken at a retail location with an electronic hand held measuring device and transmitted to a computer to generate an order. The measurements were then transmitted to a remote location where the garment was manufactured. The custom tailored garment was then sent back to the retail outlet for delivery to the customer. However, the method of the present invention does not entail manufacture of a custom fitting garment, but rather customization of the appearance of an existing off-the-rack garment.

A garment customizing method and apparatus was disclosed in Carnicella, U.S. Pat. No. 4,774,728, granted Oct. 4, 1988, wherein an embroidery machine was employed to create a master design and then a plurality of derivative designs, which could then be severed into individual patches, which were then able to be secured to an article of apparel by adhesive or other suitable means. In comparison, the method of the present invention may utilize such an embroidered patch as an embellishment, but does not manufacture embroidery patches.

An advancement in the production of individualized custom fitted clothing was disclosed in Ramsey et al., U.S. Pat. No. 6,516,240, granted Feb. 4, 2003, wherein the customer provided critical measurement information interpreted by a controller, and the controller then determined the pattern data used to produce the custom-made clothing. As stated in '376 above, the method of the present invention does not entail manufacture of a custom fitted garment, but rather customization of the appearance of an existing off-the-rack garment.

In regard, to decorating clothing, Zic et al., U.S. Pat. No. 6,868,555, granted Mar. 22, 2005, discloses a multifunctional jewelry piece which could be used to convert a style of clothing, to provide ornamentation to clothing, or to provide ornamentation to a person's body. Whereas the method of the present invention may personalize jewelry or utilize jewelry as an embellishment, it does not disclose manufacture of jewelry or reversibly modifying the shape of clothing by jewelry.

For personalized personal care products, Henderson, U.S. Pat. App. No. 2006/0036454, published Feb. 16, 2006, discloses a business method for preparing and delivering a custom personal care composition in a retail point-of-sale environment or a remote location in which the personal care product base composition is prepared. The business method typically includes a plurality of product base options, a plurality of fragrance options, and a plurality of customizing agent options. However, the method of the present invention does not disclose manufacture of a custom personal care composition, but rather customization of the appearance of an existing article.

The prior art methods do not address the method of the present invention and inhibit the customer by requiring him or her to pre-purchase the articles for embellishment prior to purchasing embellishments, generally at different locations, subject to the availability of amateur skill and machines. The method of the present invention provides for a package price, and at the same place as purchase of the article, the customer receives professional services to complete personalization of an article, that is a significant departure from the prior art.

### BRIEF SUMMARY OF THE INVENTION

The method of the present invention provides a one-stop, retail location combining professionally supervised article and apparel design, purchase and decoration not available in the prior art. Customers are not restricted to utilizing the method in the retail store, but may access the steps of the method online through a proprietary web portal application. Articles that may be personalized or customized include but are not limited to apparel such as shirts, blouses, skirts, dresses, pants, jeans, under garments, hats, shoes, other articles for wearing such as jewelry, and utilitarian articles such as wine bottle covers, pillow cases, sheets, totes, aprons and Christmas stockings, whose appearance may be modified by customer choices.

The method of the present invention of merchandising article personalization services to the public by preparing and delivering a personalized article to a customer at a retail location comprises providing in the retail establishment a plurality of personalizable articles such as apparel, jewelry or other articles, a plurality of personalization selections such as embroidery and fabric, a means to apply the personalization selections to the article by hand or with the aid of a machine, and presenting the finished article to the customer.

The method of the present invention overcomes the limitations of the related art by reducing the expense and shortening the amount of time required to personalize an article for a customer, by providing the resources and professional expertise needed to complete a personalization project in one location, from article purchase to completion of the project. Before the advent of the present invention, there was not provided in one retail location the professional expertise and professional tools for an amateur to complete an article personalization project. Quality of workmanship, dispersal of articles and supplies, unavailability of dedicated space, the professional or industrial-quality machines required to perform tasks, and the time required to coordinate these necessary resources made the task for the amateur time consuming and difficult with inconsistent quality.

A system and method is also disclosed, via a computer based web portal, for personalization of articles thereby allowing the customer to obtain professional quality customized goods without the time and travel expense to the retail store. By using the web portal application the customer responds to a series of programmed questions and prompts which are produced and processed by web accessible store computer and compiled on a computer storage medium into an order to be completed by a store worker. The details of the order are displayed on a computer terminal for worker action, or on a printed medium, the worker completes the personalization of the article, and the personalized article is forwarded to the customer. Thus the system of the present invention provides all the tools necessary for the customer to obtain a personalized article of professional quality.

In yet another aspect of the invention, a business method is provided relating generally to a method of merchandising personalized or customized apparel or articles, including but not limited to shirts, blouses, skirts, dresses, pants, jeans, under garments, baby clothes, other apparel, or other articles for wearing such as jewelry, wine bottle covers, pillow cases, totes, aprons and Christmas stockings, whose appearance is modified by customer choices in a retail sales environment, or by retail online selection and ordering.

Thus the business method of the present invention enables a customer to have an article of apparel personalized to suit the desires of the customer at a professional apparel retail establishment without having to buy the apparel or embellishments prior to the process. The business method may be implemented through providing the service at a retail establishment or through a proprietary web portal application programmed to accept instructions to produce the product.

It is an object of the invention to provide a one-stop shopping location for a customer to purchase and personalize apparel or other articles in one place, and take the article with them upon completion.

It is further object of the invention to provide professional apparel and article purchase and personalization services to the customer in a retail establishment.

It is a further object of the invention to provide a one-stop shopping location for a customer to purchase and personalize apparel or other articles in one place by accessing a database through a proprietary web portal application on a computer in the retail establishment or at a remote location on a remote server or other computer, then make selections available by that computer application that are acted upon by a store employee to complete the project.

### BRIEF DESCRIPTION OF THE DRAWING

FIG. 1 is a flow diagram illustrating a preferred embodiment of the method of the invention.

### DETAILED DESCRIPTION OF THE INVENTION

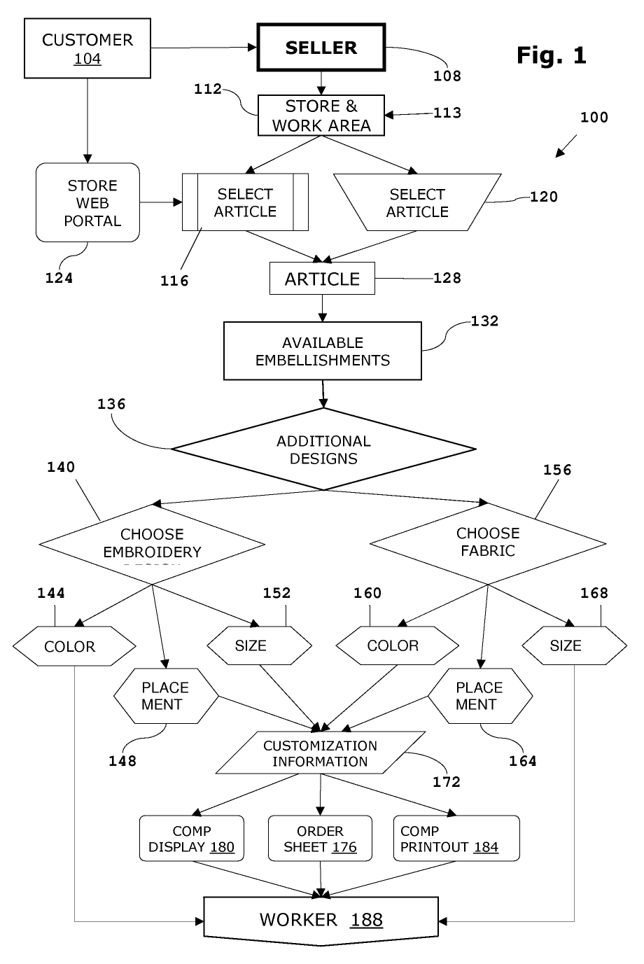

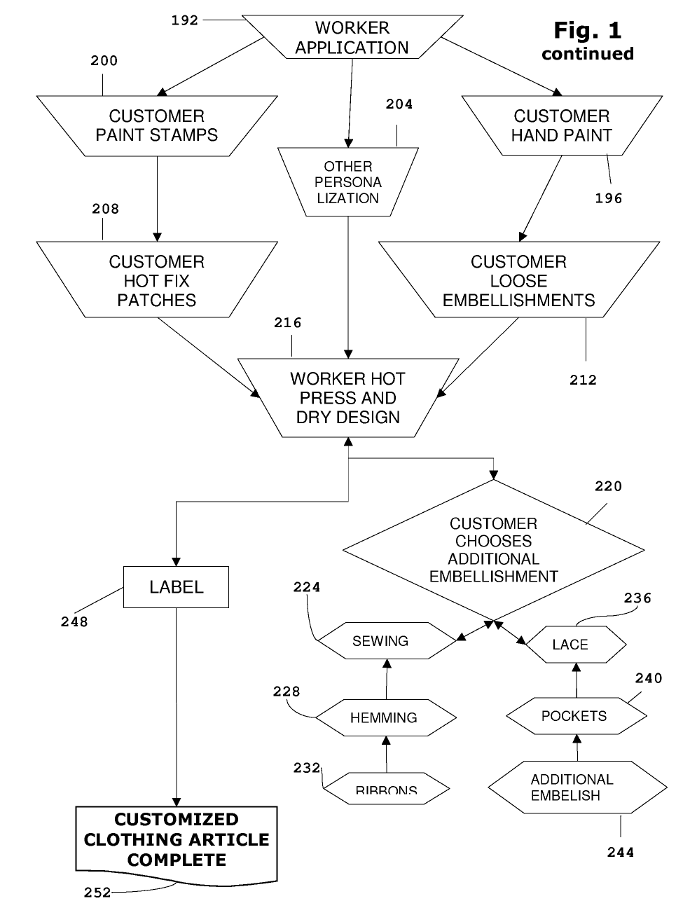

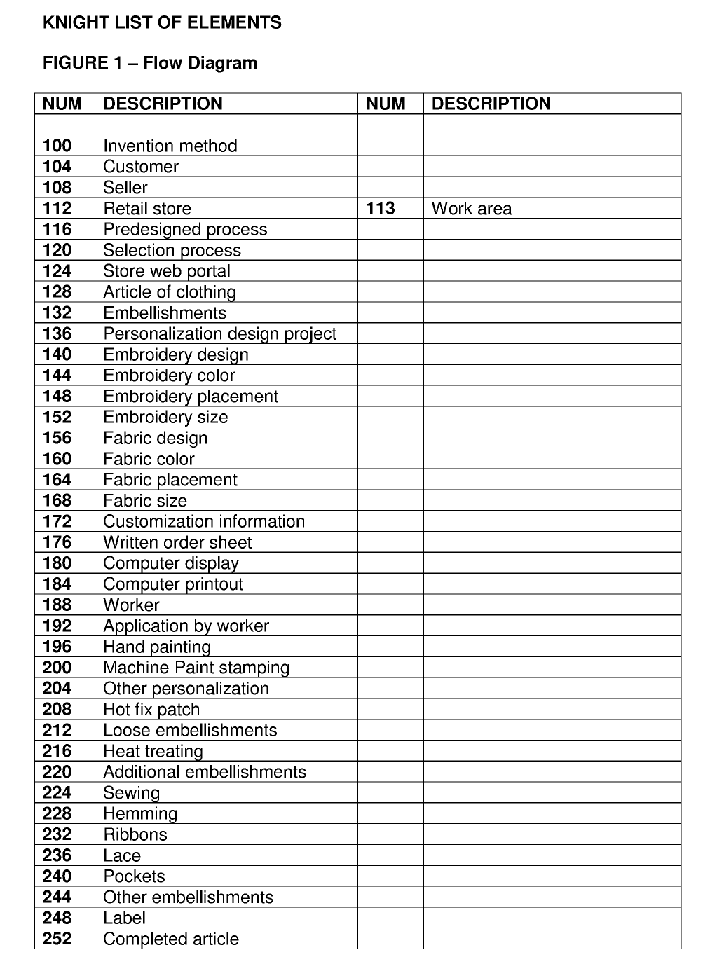

The present invention is described more fully by reference to the preferred embodiment of FIG. 1. However, the embodiments of the invention may be in different forms and these drawings should not be construed as limiting the scope of the invention as described herein. FIG. 1 is illustrious of an embodiment of the present invention and is in accord therewith.

The method of the present invention substantially departs from the conventional method of individual attempts at apparel or other article embellishment and personalization by providing a single, centralized, up-to-date retail fashion source and work area for untrained individuals and groups to partake in the personalization process and produce a personalized article with professional results. The individual may utilize these centralized professional resources by visiting the retail establishment in person, or by accessing the resources through an online web portal.

In an embodiment of the present invention is a method of preparing and providing at a retail store location a personalized article of apparel to a customer at a retail location in which the personalized apparel article is produced, comprising offering the customer a choice of a plurality of apparel articles to customize, offering the customer a choice of at least one personalization option, providing on site a means to apply, affix, embroider or otherwise attach the personalization selection to the article, and presenting the finished personalized apparel article to the customer. In this preferred embodiment of merchandising, the customer initiates the personalization process of the present invention by entering the retail establishment and selecting at least one article and at least one personalization embellishment. The customer is enabled to complete personalization of an article according to their time and ability using the professional services provided by the retail store personnel and equipment. Embellishment selections such as embroidery requiring trained personnel and specialized equipment to complete are given to a store worker for processing. Upon final selection by the customer of the embellishments, and processing by store workers, the completed article of apparel is given to the customer, retained at the retail establishment until the customer returns, or forwarded to the customer at their request.

In a further embodiment of the present invention is a method for preparing and delivering to a customer a personalized non-apparel article, comprising providing one or more articles for personalization, including but not limited to wine bottle covers, pillow cases, totes, aprons, Christmas stockings and the like, a plurality of personalization options for selection, a means to apply the personalization selections to the article, and presenting the finished product to the customer. Preferably the personalization process for an article would proceed as above for apparel.

In a further embodiment of the present invention is a method for preparing and delivering a personalized article, or article of apparel, to a customer at a location remote from a second location in which the personalized article is produced, comprising a centralized digital data set of a plurality of articles and personalization options comprising a database stored on a computer accessible storage medium such as a hard drive, memory device or disc, a means to apply the selections to the articles, and a means to deliver the finished product to the customer. The computer program for analyzing the data characterizing the personalization selections of the customer may be stored in the memory of the same or a different computer than the computer in which the data is stored. Similarly, the computer in which the computer program for analyzing the data characterizing the personalization selections of the customer is stored may accesses the computer in which the data is stored via Internet, Intranet, or other network connection.

This embodiment is self-implemented by the customer preferably accessing a network enabled computer with a user interface application to navigate to a proprietary store web portal url which retrieves a webpage application located on a remote network server or other computer. Information on apparel, other articles and personalization selections, and directions on how to personalize the articles online, is provided by the webpage application from a computer accessible database. The web portal application directs the customer to input selection data in response to programmed queries. Customers proceed to select and personalize articles through the web portal that comprises the links to the various personalization processes of the present invention. The selection data is input through the web portal and converted into an accessible digital form, stored, analyzed and compiled into a data set according to a plurality of personalization parameters, displayed on a monitor and/or printed at the retail store, for action by a store employee to implement the selections. Preferably, the web portal application acts as a way to monitor progress throughout the article personalization process. Each step is indicated on the web portal application.

Once initiated the article personalization process may be interrupted and completed at any time as long as the compiled data set is available on a computer as stated above. The user can then readily determine what steps have been performed, and complete the project as time permits. An advantage of the web portal application is that the personalization process can be accessed at any time and the user can self-implement the selections and manage the personalization at any time at any location remote from the retail store, or at a store terminal.

In another embodiment of the present invention, the network accessible proprietary web portal and application is provided on a computer in the retail store location, and is utilized as stated in the remote procedure above, and incorporated herein by reference. In this embodiment the customer may initiate the personalization method at a remote compute as above, at the store computer, or any combination thereof until the article is completed. The method of the present invention overcomes any limitations of the related art in that the embellishment and selection data set compiled by the customer on the proprietary web portal application is centrally controlled through a store management controlled server, or other computer, and accessible only at one source through the proprietary web portal application via the network connection. Thus, this centralized data set may be automatically updated through command functions of the network application of the invention.

In another aspect of the invention is a business method for merchandising personalized services for articles such as apparel and non-apparel items to a customer at a retail location, comprising the steps of providing the customer with choice of a plurality of apparel articles to customize, offering the customer a choice of at least one personalization option, providing on site a means to apply, affix, embroider or otherwise attach the personalization selection to the article, and presenting the finished personalized apparel article to the customer. In this preferred embodiment of merchandising, the customer initiates the personalization process of the present invention by entering the retail establishment and selecting at least one article and at least one personalization embellishment. The customer is enabled to complete personalization of an article according to their time and ability using the professional services provided by the retail store personnel and equipment. Embellishment selections such as embroidery requiring trained personnel and specialized equipment to complete are given to a store worker for processing. Upon final selection by the customer of the embellishments, and processing by store workers, the completed article of apparel is given to the customer, retained at the retail establishment until the customer returns, or forwarded to the customer at their request.

In another aspect of the invention is a business method for merchandising personalized articles such as apparel and non-apparel items to a customer utilizing a proprietary web portal application, comprising the steps as stated above and incorporated herein by reference.

In another aspect of the invention, a labeling device applies a customized label to the article containing the personalization data compiled in the computer database by the customer for the finished article. The labeling device may produce the label by any suitable means, preferably by a computer interfaced with a printer, or other indicator device such as an embroidery machine, which allows for the employee to input the customer's personalization selections and accesses the proprietary data set described above to produce a customized label. In another aspect of the invention the same or a different labeling device may also be used to insert a code on the label, e.g. a machine-readable bar code or the like, capable of tracking the identity of both the completed article and the customer for later reference. In a further embodiment the label contains an electronically read-writable apparatus, such as an RFID tag, which is electronically interfaced with the computer database herein described permitting the worker to store the customer data in the tag in the label. Thus, the customer can reorder a reproduction of the personalized article by the store accessing the data in the label, whether it be sewn in, printed such as a bar code, or electronically stored in a read-writable tag. The customer may also return to the store and allow the previous label to be electronically scanned to retrieve stored customer preferences thus facilitating the purchase of additional personalized products.

In another aspect of the invention, a plurality of customer personalization selections may be compiled in a database for subsequent access by the store, or the customer, to facilitate ordering a reproduction of the same article, or an additional article. The additional article is preferably an article that may be personalized by one or more of the stored customer selections. For example, one or more of the stored personalization selections for a pair of jeans may be retrieved for affixing to a different article, such as a blouse or a tote.

For a more complete understanding of the present invention and its advantages, reference is now made to the following description taken in conjunction with the accompanying figures:

Referring now to the method of the present invention, FIG. 1 is a flow diagram of a preferred embodiment of the present invention 100 illustrating the various customer 104 input and decision steps, in addition to the worker 188 tasks to complete a personalized article of apparel 252, such as a pair of jeans. The method is initiated by the seller 108 offering one or more types of articles of apparel 128 in a retail store 112 with a work area 113. Reference to FIG. 1 demonstrates how a customer 104 can customize apparel 128 for personalization. Variety in apparel styles, colors, fit and brands is provided by the seller 108 to optimize choices for the customer 104. The customer 104 enters the store 112 and goes through the manual process 120 of selecting apparel 128 for personalization, or accesses the store web portal 124 from a networked computer and determines the type and brand of apparel 128 to customize through a proprietary pre-designed computer facilitated process 116 showing a plurality of embellishments 132 provided by software on the web portal 124. After reviewing the available offered embellishments 132 the customer 104 selects the embellishments 132 for inclusion on the article. The embellishments 132 preferable include additional design parameters 136 if the customer desires to include an additional design on the article 252. The additional design parameters 136 preferably include but are not limited to embroidery 140 and fabric 156 designs. The customer 104 then proceeds to choose from a plurality of embellishment parameters including but not limited to color 144, size 152 and placement 148 of an embroidery design 140 and/or the color 160, size 168 and placement 164 of a fabric design 156 on the article of apparel 128. The combined embellishments and any parameters are compiled as customer specific customization information 172 in the memory of a computer as an accessible database which is then analyzed by a computer program stored in the memory of a computer to produce directions for implementing the selections of the customer programmed provided to a worker 188 in the store 112 by means of a written order sheet 176, an electronic computer display 180 or an electronic computer printout 184. If the customer 104 placed the order through the web portal 124 the information 172 would preferably be displayed on a computer 180. The web portal 124 directs the customer 104 to input information 172 in response to proprietary software programmed queries from the web portal application on a remote server or other computer accessible storage medium.

The worker 188 then gathers the selected embroidery 140 and fabric 156 embellishments and applies 192 them to the apparel 128 in the placement designated by the customer 104. After the worker application 192 of embroidery 140 and/or fabric 156 is completed, the customer 104 may further personalize the apparel 128 by manually hand painting 196, by machine paint stamping 200 additional designs on the apparel 128, by attaching hot fix patches 208 of any design, by attaching loose embellishments 212 such a beads or rhinestones, or by using other personalization criteria 204. The apparel 128 is then returned to a store worker 188 for further processing if recommended, such as pressing or heat treating or drying 216. The article 128 may now be a completed article 252, or the customer 104 may choose additional embellishments 220 such as sewing 224, hemming 228, attaching ribbons 232, lace 236, pockets 240, and any other additional embellishments 244 such as those provided by the customer 104. Any embellishment not requiring hands-on work by the customer 104 may be selected through the web portal 124. The article 128 is finished processed by the store worker 188 if recommended by the seller 108, or if requested by the customer 104, and the customized apparel 252 is completed for the customer 104. A further preferred embodiment of the present invention provides a manually or electronically readable label 248 that contains the article and personalization data affixed therein, and is attached to the article 252 by the worker 188 after completion. If the customer 104 has come to the retail location 112, the completed article 252 is given to the customer, or if ordered on-line the article 252 is packed and shipped to the customer 104 in a timely manner.

The store 112 and work area 113 preferably provides a work space for an individual, a family, or even a group of customers 104 to participate in the selection, customization and personalization of articles. Groups of customers 104 may include but are not limited to family members, birthday and special events celebrants, sports teams, and business associates, may congregate in the store 112 and work area 113 for the purpose of selecting and customizing such articles 128.

Thus the method of the present invention provides a hands-on or online service for personalization and customization of non-apparel articles 128 by an untrained customer 104. As stated above, a customer(s) 104 by the method of the present invention 100 would preferably enter the personalization process at steps 116 or 120 and then proceed sequentially through the process as shown in FIG. 1 and incorporated herein by reference.

It is understood that the embodiments and descriptions of the invention herein described are merely instruments of the application of the invention and those skilled in the art should realize that changes may be made without departure from the essential elements and contributions to the art made by the teachings of the invention herein.

What is claimed is:

1. A method by a seller of producing at a retail store location a personalized article for a customer, comprising the steps of:
(a) providing a work space in a retail store for a customer;
(b) offering the customer at least one article to personalize;
(c) selecting an article to personalize by the customer;
(d) offering the customer at least one embellishment to add to the article;
(e) selecting an embellishment by the customer;
(f) inputting data characterizing the personalization selections of the customer into the memory of a computer;
(g) analyzing the data in the memory of the computer using a computer program stored in the memory of a computer to produce customer specific directions for affixing the embellishment to the article;
(h) providing in the retail store means to affix the embellishment to the article;
(i) implementing the customer specific directions;
(j) presenting the completed personalized article to the customer.

2. The method of claim wherein the article is chosen from a group of apparel articles comprising shirts, blouses, skirts, dresses, pants, jeans, under garments and baby clothes.

3. The method of claim 1 wherein the article is chosen from a group of non-apparel articles consisting of jewelry, wine bottle covers, pillow cases, totes, aprons and Christmas stockings.

4. The method of claim 1 wherein the embellishment is chosen from a group consisting of embroidery, fabric, paint stamp, hand painting, hot fix patch, loose embellishment, sewing, lace, hemming, ribbons and pockets.

5. The method of claim 1 wherein the means to affix the embellishment is a heat source.

6. The method claim 1 wherein the customer specific directions additionally comprise an electronically accessible label affixed to the article containing the personalization selections compiled in the computer memory.

7. The method of claim 1 wherein the computer program for analyzing the data characterizing the personalization selections of the customer is stored in the memory of a different computer than the computer in which the data is stored.

8. The method of claim 1 wherein the computer in which the computer program for analyzing the data characterizing the personalization selections of the customer is stored accesses the computer in which the data is stored via Internet, Intranet, or other network connection.

9. A personalized article produced in accordance with the method of claim 1.

10. A business method by a seller of merchandising article personalization services from a retail store to produce customized articles for customers, comprising the steps of:
(a) providing a work space in a retail store for a customer;
(b) offering the customer at least one article to personalize;
(c) selecting an article to personalize by the customer;
(d) offering the customer at least one embellishment to add to the article;
(e) selecting an embellishment by the customer;
(f) inputting data characterizing the personalization selections of the customer into the memory of a computer;
(g) analyzing the data in the memory of the computer using a computer program stored in the memory of a computer to produce customer specific directions for affixing the embellishment to the article;
(h) providing in the retail store means to affix the embellishment to the article;
(i) implementing the customer specific directions;
(j) presenting the completed personalized article to the customer.
